(19) United States
(12) Patent Application Publication
(10) Pub. No.: US 2026/0233976 A1
(43) Pub. Date: Aug. 13, 2026

(54) A Method and a Blade Lifting Yoke for Lifting a Wind Turbine Rotor Blade

(71) Applicant: LIFTRA IP APS, Aalborg SV (DK)

(72) Inventors: Per Eske Fenger, Terndrup (DK); Alexander Becsei Christiansen, Aalborg SV (DK)

(21) Appl. No.: 19/153,335

(22) PCT Filed: Feb. 1, 2024
(86) PCT No.: PCT/EP2024/052525

§ 371 Date: Aug. 3, 2025

(30) Foreign Application Priority Data
Feb. 2, 2023 (DK) PA202370063

(51) Int. Cl. B66C 1/10; B66C 23/18; F03D 13/10

(52) U.S. Cl. CPC B66C 1/108; B66C 23/185; F03D 13/104; F05B 2230/61

(57) ABSTRACT

A blade lifting yoke includes a crane attachment section, a base section, a holding device, first and second upper and lower clamping elements, and a support element attached to the holding device. The first and second upper clamping elements are arranged substantially perpendicular to the longitudinal direction to each other above the respective first and second lower clamping elements. The support element contacts a second surface of the rotor blade a predetermined distance from one of the first and/or second lower clamping elements. A clamping mechanism contacts the first and second upper and lower clamping elements, and clamps the rotor blade such that during hoisting operation, the first and second upper and lower clamping elements and the support element provide static stability of the wind turbine rotor blade relative to the blade lifting yoke.

### CROSS-REFERENCE TO RELATED APPLICATIONS

This application is the national phase of, and claims priority to, International Application No. PCT/EP2024/052525, filed 1 Feb. 2024, which claims priority to Danish Patent Application No. PA 2023 70063 filed 2 Feb. 2023.

### FIELD OF INVENTION

The invention relates to a blade lifting yoke and a method for lifting a wind turbine rotor blade using a blade lifting yoke.

### BACKGROUND OF THE INVENTION

As wind turbine rotor blades becomes larger and heavier, the requirement for hoisting equipment, such as a blade lifting yoke, is also getting larger and heavier. The increased size and/or weight of the blade lifting yoke has several drawbacks. For example, a hoisting operation for hoisting a larger load requires cranes with larger capacity. Especially in the wind turbine industry, the hoisting operation also requires handling the assembly of a wind turbine rotor blade to a nacelle arranged on the top of a wind turbine tower. Handling a heavy load is complicated and there is an increased risk of damage to both the rotor blades and the nacelle.

For example, EP3792211 discloses a blade lifting tool, such as a yoke, for lifting a wind turbine rotor blade by means of a crane for subsequent assembly with a wind turbine. The blade lifting tool has at least one holding device for holding the wind turbine blade. The holding device comprises a movable supporting element for supporting the wind turbine blade and at least one actuator connected to the at least one movable supporting element. Some of the moveable supporting members are used for clamping the rotor blade. The rotor blade is kept in a firm grip thereby compensating for motions during operation. Other moveable supporting elements may passively be used for supporting the wind turbine rotor blade, wherein the wind turbine rotor blade rests on the moveable supporting elements, which are designed to support the weight of the wind turbine blade, such that the wind turbine rotor blade is held in the blade lifting tool safely. The moveable supporting elements, arranged as a cradle shaped holding area, are provided to be adjusted the rotor blade, to be able to rest in a cradle shaped lower resting. The moveable supporting elements support the weight of the wind turbine blade but are also part of the clamping function. The moveable lower supporting elements are arranged under or just beside the moveable upper supporting elements, wherein the moveable lower supporting elements and the upper supporting elements are used for clamping the wind turbine rotor blade. This construction is large and heavy. The solution, presented by EP3792211, concerning how to hold the rotor blade relative to the blade lifting yoke in a firm grip during hoisting operation is to increase the clamping pressure.

The blade lifting yoke must be able to hold the rotor blades in a steady position during hoisting operation, regarding the shape of the rotor blade and weather condition. To hold the rotor blade in a firm grip the blade lifting yoke increases the gripping pressure. Because the rotor blade is increasing in size and weight, the risk of damage the wings due to a high gripping pressure is also increasing.

Furthermore, when the blade lifting yoke is larger and heavier, there is also the need for more component material which increases the manufacturing costs. Also, the costs for transportation increases as well.

### SUMMARY OF THE INVENTION

It is an object of the invention to overcome these problems by providing a method for lifting larger wind turbine rotor blades in a safe, steady and secure way, without causing the wind turbine rotor blade any unnecessary damage during hoisting. An object of the invention is furthermore to provide a robust and light weighted blade lifting yoke for lifting a wind turbine rotor blade.

The invention addresses this by providing a method for lifting a wind turbine rotor blade using a blade lifting yoke, wherein the blade lifting yoke has at least one crane attachment section for attachment to a crane, wherein the blade lifting yoke comprise a base section and at least one holding device, wherein the blade lifting yoke comprises a first upper and lower clamping element, a second upper and lower clamping element and a support element attached to the at least one holding device comprising an extended member, wherein the extended member extends away from the nearest lower clamping element, such that the support element is capable of supporting the lower surface of said rotor blade in a predetermined distance from the first or second lower clamping elements, wherein each of the first and second upper clamping elements are arranged above the respective first and second lower clamping elements, which are arranged in each respective first and second distances substantially perpendicular to a longitudinal direction of the rotor blade above the respective first and second lower clamping elements, wherein the first and second upper clamping elements configured for pressing the rotor blade against the respective first and second lower clamping elements, wherein the method comprises the following acts of:
a) determining a first and a second clamping position for the first upper and lower clamping elements and the second upper and lower clamping elements, and determining a support position of the support element relative to a selected rotor blade when arranged in the blade lifting yoke, and determining a clamping pressure between the first and second upper clamping elements and the respective first and second lower clamping elements,
b) arranging the selected rotor blade relative to the at least one holding device, such that said first and second upper clamping elements are arranged adjacent to a first surface of said selected rotor blade at the predetermined clamping positions of the respective first and second upper clamping elements, and said first and second lower clamping elements are arranged adjacent to a second surface of said selected rotor blade relative to the predetermined clamping position of the first and second lower clamping elements,
c) arranging said support element adjacent to the second surface in a predetermined distance from the first and/or second lower clamping element, wherein the support element is arranged in a predetermined support position between a center of gravity and a trailing edge of the wind turbine rotor blade,
d) adjusting said clamping pressure between said first and second upper clamping elements and said respective first and second lower clamping elements using a clamping mechanism, keeping the center of gravity of a wind turbine rotor blade substantially in or near of a rotor blade's clamping area, wherein the clamping area are defined by the first and a second clamping positions of the first and second upper clamping elements and the first and second lower clamping elements, wherein during hoisting operation, the first and second upper clamping elements, the first and second lower clamping elements and the support element are providing static stability of the wind turbine rotor blade relative to the blade lifting yoke.

Today the rotor blades are getting larger and heavier, and more difficult to handle. There is a need for light weighted blade lifting yoke constructions which include voiding the complexity of a heavy weight. The total weight of the blade lifting yoke is preferred to be kept as low as possible. The invention presents a simple, robust, and agile light weighted blade lifting yoke construction, which is capable of handling large and heavy rotor blades during hoisting operations. When a rotor blade, such as a wind turbine rotor blade, is handled during hoisting operation, it is crucial that the rotor blade is clamped in a secured position in a blade lifting yoke.

The blade lifting yoke has a crane attachment section for attachment to a crane, such that the crane or outer lifting equipment is capable of lifting the blade lifting yoke carrying a rotor blade in a safe, steady, and secure way. The hoisting operation may involve lifting and lowering heavy wind turbine rotor blades to and from a wind turbine nacelle placed on a tower. Furthermore, the hoisting operation may involve holding and turning the rotor blade during connection to and from a wind turbine nacelle. Also, issues related to static forces and moments must be taken into consideration when handling a rotor blade using a blade lifting yoke.

The blade lifting yoke comprises a base section and at least one holding device. The blade lifting yoke comprises at least two upper clamping elements, e.g., at least one first and at least one second upper clamping element. The blade lifting yoke comprises at least two lower clamping elements, e.g., at least one first and at least one second lower clamping element. The upper clamping elements are configured to press the rotor blade against the respective lower clamping elements, such that the rotor blade is kept in a substantially firm and secured hoisting position.

The support element is arranged relative to either the first or the second lower clamping element. The support element is arranged in a support position wherein the support element and the first or the second lower clamping element is located on a cross sectional line of the rotor blade. The support element is arranged in a support position away from a clamping area. Each of the upper clamping elements are arranged in a distance substantially perpendicular to the longitudinal direction above the respective lower clamping element. Each of the upper clamping elements is capable of pressing the rotor blade against the lower clamping element and keeping the rotor blade in a substantially fixed position relative to the lifting yoke. It is important the clamping pressure is kept as low as possible to avoid any damage to the rotor blade during hoisting operation.

The position of the first upper and lower clamping elements and the second upper and lower clamping elements is arranged in a clamping position with distance to each other. The clamping position of the first upper and lower clamping elements and the second upper and lower clamping elements is determined based on the type of rotor blade, for example the rotor blade's center of gravity, COG, length, shape, weight, etc. The position of the support element is determined based the first or second clamping element and on the type of rotor blade, for example the rotor blade's center of gravity, length, shape, weight, etc. The clamping pressure between the upper clamping elements and the respective lower clamping elements is determined based on the type of rotor blade, for example the rotor blade's center of gravity, length, shape, weight, etc. The clamping pressure between the first and second upper clamping elements and the respective first and second lower clamping elements may also be determined based on weather conditions present during hoisting operations.

The rotor blade is arranged in a clamping position relative to the holding device. The first and second upper clamping elements are arranged adjacent to a first surface of said rotor blade in their respective predetermined clamping positions. The upper clamping elements may be arranged in contact with or relative to the first surface. The first and second lower clamping elements are arranged adjacent to a second surface of said rotor blade in their respective predetermined positions. The lower clamping elements may be arranged in contact with or relative to the second surface.

The support element is arranged in a predetermined position adjacent to the second surface. The support element may be arranged in contact with or relative to the second surface. The support element is arranged in a predetermined distance from the lower clamping element. The support element is arranged in a predetermined position between a center of gravity and a trailing edge of the wind turbine rotor blade.

A clamping pressure is provided between each of the upper clamping elements and each of the respective lower clamping elements using a clamping mechanism. The clamping pressure may keep the center of gravity of the rotor blade substantially in or near a clamping area of the rotor blade between the upper clamping elements and the lower clamping elements.

When arranging a selected rotor blade in the blade lifting yoke, the blade lifting yoke may be arranged in an open position, such that the distance between the first and second upper clamping elements and second lower clamping elements may be increased. The first and second upper clamping elements is moved away from their clamping position relative to the first and second lower clamping elements, such that the rotor blade safely may be arranged in a predetermined position in the blade lifting yoke. The rotor blade is arranged in a resting position on the first and second lower clamping elements. The support element may be arranged in the predetermined support position relative to the rotor blade and the lower clamping elements.

The rotor blade may be arranged in the resting position, wherein at least 50% of the weight of the rotor blade is resting on the first and second lower clamping elements. Preferably, the rotor blade may be arranged in the resting position, wherein at least 60% of the weight of the rotor blade is resting on the first and second lower clamping elements. Most preferably, the rotor blade may be arranged in the resting position, wherein at least 70% of the weight of the rotor blade is resting on the first and second lower clamping elements. When the rotor blade is arranged in the resting position in the blade lifting yoke, the blade lifting yoke may be arranged in a closed position. The distance between the first and second upper clamping elements and second lower clamping elements is decreased and moved into clamping position. The blade lifting yoke may be arranged in a releasable locked position, such that the blade lifting yoke does not unintentionally open during hoisting operation. The upper clamping elements, the lower clamping elements, and the support element provides static stability of the wind turbine rotor blade relative to the blade lifting yoke.

In an advantageous method of the invention, the support element is located adjacent to the second surface in a predetermined support position in a support distance from the trailing edge, such that more than 70% of a rotor blade's weight is resting on the first and the second lower clamping elements.

The support element is arranged adjacent to the second surface. The support element may be located in a predetermined position in a support distance from the trailing edge. The predetermined distance between the support element and the first and second lower clamping element ensures the static stability of the rotor blade when arranged in the blade lifting yoke. The static stability is provided by using a three-point principle. A three-point static stability occurs when three forces related to the first and second lower clamping elements and the support element positions relative to the rotor blade are arranged in such a way that a single primary force is applied between two additional counterforces with the sum of all three forces equalling zero. The support element support position is preferably located outside the rotor blade's clamping area. The support element is not a part of the clamping process. The support element is arranged in a predetermined support position and applies a force to the second surface, wherein the force is relative to the weight of the rotor blade which rests on the first and the second lower elements.

The force applied to the predetermined support position on the second surface causes more than 70% of a rotor blade's weight to rest on the first and the second lower elements. Preferably the predetermined support position causes more than 80% of a rotor blade's weight to rest on the first and the second lower elements. More preferable, the predetermined support position causes more than 90% of a rotor blade's weight to rest on the first and the second lower elements.

When most of the rotor blade's weight is resting on the first and the second lower elements, the clamping pressure may be reduced significantly. This ensures an optimal handling of the heavy rotor blade during hoisting operation.

The support distance measured from the trailing edge along the second surface may be within a distance of 10-50% of a surface distance measured from a leading edge to the trailing edge along the second surface. Preferably the support distance may be within a distance of 20-50% of the surface distance measured from the leading edge to the trailing edge along the second surface. More preferably the support distance may be within a distance of 30-50% of the surface distance measured from a leading edge to the trailing edge along the second surface.

The support element is adapted to be arranged in a predetermined position, wherein the support element applies a force to the second surface. By providing a force to the second surface, the center of gravity may be retained in a predetermined COG position relative to the blade lifting yoke, thereby preventing the rotor blade unintentionally to slide out of the gripping position during hoisting operation. The support element will provide increased safety and reduce the need of an increased clamping pressure, which may damage the rotor blade.

In an advantageous method of the invention, a first clamping pressure provided between the first upper and lower clamping elements is different than a second clamping pressure provided between the second upper and lower clamping element.

Weather conditions and other conditions related to the hoisting operation may require that clamping pressure may be reduced and increased. To avoid a constant high pressure which may damage the rotor blade, the clamping pressure, both the first and the second clamping pressure may be predetermined according to the type of rotor blade and/or weather conditions. During hoisting operations, the first clamping pressure provided between the first upper and lower clamping element may be different than a second clamping pressure provided between the second upper and lower clamping element. The first clamping pressure and the second clamping pressure may be varied to increase the stability during the hoisting operation.

In a further advantageous method of the invention, a first clamping distance between the rotor blade's center of gravity and the first upper and lower clamping elements is different from a second clamping distance between the rotor blade's center of gravity and the second upper and lower clamping elements.

Weather conditions and other conditions related to the hoisting operation may require that clamping positions of the first upper and lower clamping elements and the second upper and lower clamping elements be displaced relative to rotor blade's center of gravity to increase the stability during the hoisting operation.
In a still further advantageous method of the invention, the first and the second clamping pressure is determined based on at least one information related to weather conditions.

The clamping pressure between the first and second upper clamping elements and the respective first and second lower clamping elements may also be determined based on weather conditions present during hoisting operation. The rotor blades of wind turbines are as expected exposed to and continuously affected by wind strengths and turbulence. The rotor blades may likely be affected by the wind situation during hoisting operations. It may be necessary to vary the clamping pressure between each of the upper and lower clamping elements relative to each other. The first and the second clamping pressure may be equal to each other during hoisting operation. Alternatively, the clamping pressure may be different from each other.

The first and the second clamping pressure may be adjustable. The first and the second clamping pressure may be independently varied during hoisting operations. The first and the second clamping pressure may be varied relative to each other to increase the stability during the hoisting operation. The first and the second clamping pressure may be varied manually and/or automatically during hoisting operation.

The clamping distance may be varied to provide enhanced clamping management of the rotor blade during hoisting operation and to increase the stability during the hoisting operation. The first clamping distance, which is the distance between a wind turbine rotor blade's center of gravity and the first upper and lower clamping element may therefore be different than the second clamping distance, which is the distance between a wind turbine rotor blade's center of gravity and the second upper and lower clamping element.

A second aspect of the invention provides a blade lifting yoke for lifting a wind turbine rotor blade, wherein the blade lifting yoke has at least one crane attachment section for attachment to a crane, wherein the blade lifting yoke comprises a base section and at least one holding device, wherein the blade lifting yoke comprises a first upper and lower clamping elements, a second upper and lower clamping elements and a support element attached to the at least one holding device, wherein the first and second upper clamping elements are arranged in a distance to each other above the respective first and second lower clamping elements, wherein the first and second upper clamping elements are configured for pressing the rotor blade against the respective first and second lower clamping elements, wherein one of the at least one holding devices comprises a support element adapted to be arranged in contact with said second surface of said wind turbine rotor blade in a predetermined distance from one of the first and/or second lower clamping element, wherein the at least one holding device comprises an extended member, wherein the support element is attached to the extended member, wherein the extended member extends away from the nearest lower clamping element, such that the support element is capable of supporting the lower surface of said rotor blade in a predetermined distance from the first or second lower clamping elements, wherein a clamping mechanism is configured to be in contact with the said first and second upper clamping elements and said first and second lower clamping elements, wherein the clamping mechanism is configured to clamp a wind turbine rotor blade with at least one clamping pressure between the first and second upper clamping element and the respective first and second lower clamping elements, such that during hoisting operation the first and second lower clamping element and the support element provides static stability of the wind turbine rotor blade relative to the said blade lifting yoke.

The invention also provides a blade lifting yoke for lifting a wind turbine rotor blade. The blade lifting yoke has a crane attachment section, such that the blade lifting yoke may be attached to a crane for hoisting operation. The rotor blade is arranged in or relative to the blade lifting yoke in such way that the rotor blade is secured during hoisting operation. The holding device comprises a first and second upper clamping element and a first and second lower clamping element. The first and second upper clamping elements and the first and second lower clamping elements are separately attached to the holding device or holding devices. The two upper clamping elements are adapted to be arranged in contact with or relative to the first surface of the wind turbine rotor blade. The first and second lower clamping elements are adapted to be arranged in contact with or relative to the second surface of the rotor blade. Each of the upper clamping elements are arranged in a distance with an angle to the longitudinal direction of the rotor blade and substantially above the lower clamping element. Each of the upper clamping elements is configured for pressing the rotor blade against the lower clamping elements, with substantially equal clamping pressure or with a predefined clamping pressure.

A holding device may comprise a support element adapted to be arranged in contact or relative to the second surface of the rotor blade in a predetermined distance away from the nearest lower clamping element. The support element may be in an elevated position relative to the nearest lower clamping element from where the support element extends from.

A clamping mechanism is configured to be in contact with the first and second upper clamping elements and the first and second lower clamping elements. The clamping mechanism is configured to clamp the rotor blade using the first upper and lower clamping elements and the second upper and lower clamping elements. The clamping mechanism controls each of the clamping elements separately and/or simultaneously, such that the first clamping pressures, which are provided by the first upper and lower clamping elements, is different or equal to the second clamping pressure, which is provided by the second upper and lower clamping elements. The first and second upper clamping elements, the first and second lower clamping elements and the support element provides static stability of the wind turbine rotor blade relative to the blade lifting yoke.

The at least one holding device comprises an extended member, wherein the support element is attached to the extended member, wherein the extended member extends away from the nearest lower clamping element, such that the support element is capable of supporting the lower surface of said rotor blade in a predetermined distance from the first and second lower clamping elements.

The one of the at least one holding device may comprise an extended member. Alternatively the holding device may be an elongated holding device comprising the extended member. The extended member may be a part of the holding device. Alternatively the extended member may be attached to the holding device and extend away from the holding device. The extended member may extend in a direction away from the lower clamping element. The extended member may be moveable, and the length may be adjustable. The extended member may be pivotally attached to the holding device. The extended member may vary the length of the extension. The support element may be attached to the extended member. The support element may be moveably displaced along the extended member. The extended member extends away from the nearest lower clamping element. The support element is capable of supporting the lower surface of said rotor blade in a predetermined distance from the lower clamping element, such that static stability of the rotor blade is provided relative to the blade lifting yoke.

In a further advantageous embodiment of the invention, the first and/or second upper clamping elements and/or the first and/or second lower clamping elements are pivotally attached to the at least one holding device.

The rotor blade may comprise different shapes and length related to the specific type of the rotor blade. The first and/or second upper clamping elements and/or the first and/or second lower clamping elements may be pivotally attached to the at least one holding device, such that it is easy for each of the clamping elements clamping surfaces to follow along the surface of the rotor blade. The first and second upper clamping element and/or the first and second lower clamping element are pivotally attached to the at least one holding device. Alternatively, the first or second upper clamping element and/or the first or second lower clamping element are pivotally attached to the at least one holding device. The combination of pivotally attached may be provided in many variations. The first or second upper clamping elements may be arranged in a pivot position relative to the first surface, such that the first and/or second upper clamping elements clamping surfaces are in contact with the first surface of the rotor blade. The first and/or second lower clamping elements may be arranged in a pivot position relative to the second surface, such that the first and/or second lower clamping elements clamping surfaces are in contact with the second surface of the rotor blade.

In a still further advantageous embodiment of the invention, said first and second upper clamping elements comprise a first and a second upper clamping member pivotally attached to said first and/or second upper clamping element, and/or said first and/or second lower clamping elements comprise a first and a second lower clamping member pivotally attached to said first and/or second lower clamping element, and/or said support element comprise a first and a second support member pivotally attached to said support element.

The upper clamping element may comprise a first and a second upper clamping member pivotally attached to the upper clamping element. The first and/or second lower clamping element comprises a first and a second lower clamping member pivotally attached to the lower clamping element and/or said support element comprise a first and a second support member pivotally attached to the support element.

Each clamping member may comprise further sub-clamping members which may be pivotally attached in pair to a prior clamping member. Further sub-clamping members may be pivotally attached in pairs to prior sub-clamping members etc. The pivotal attachments may be a type of pivot joints or ball joints or similar, which allows the movement needed. The purpose is to provide a single contact point between the at least one holding device and the respective upper clamping elements, lower clamping elements and the support element, such that the three-point principle is retained to ensure static stability of the wind turbine rotor blade relative to the blade lifting yoke.

A control system may comprise controlling means configured to control a clamping pressure between the first and second upper clamping element relative to the first and second lower clamping element. The clamping pressure may be derived from the amount of weight of the rotor blade which is resting on the first and second lower element. The controlling means is capable of controlling the movement of the rotor blade, such that the center of gravity of the rotor blade moves relative to the blade lifting yoke. The center of gravity may be adjusted towards a predetermined position during hoisting operations.

This invention has now been explained with reference to a few embodiments and methods, which have only been discussed to illustrate the many varying possibilities achievable according to the invention.

### BRIEF DESCRIPTION OF THE DRAWINGS

The embodiments of the invention are described in the following with reference to:

FIG. 1: Illustrating a crane hoisting a blade lifting yoke with a rotor blade.

FIG. 2a, b: Illustrating two different embodiments of a blade lifting yoke lifting a rotor blade.

FIG. 3a, b, c: Illustrating a cross sectional embodiment of a blade lifting yoke lifting a rotor blade.

FIG. 4a, b: Illustrating predetermined support and clamping positions on a rotor blades surface.

In the explanations of the figures, identical or corresponding elements will be provided with the same designations in different figures. Therefore, no explanation of all details will be given in connection which each single figure/embodiment.

### DETAILED DESCRIPTION

Embodiments of the invention are explained in the following detailed description. It is to be understood that the invention is not limited in its scope to the following description or illustrated in the drawings. The invention is capable of other embodiments and of being practiced or carried out in various ways.

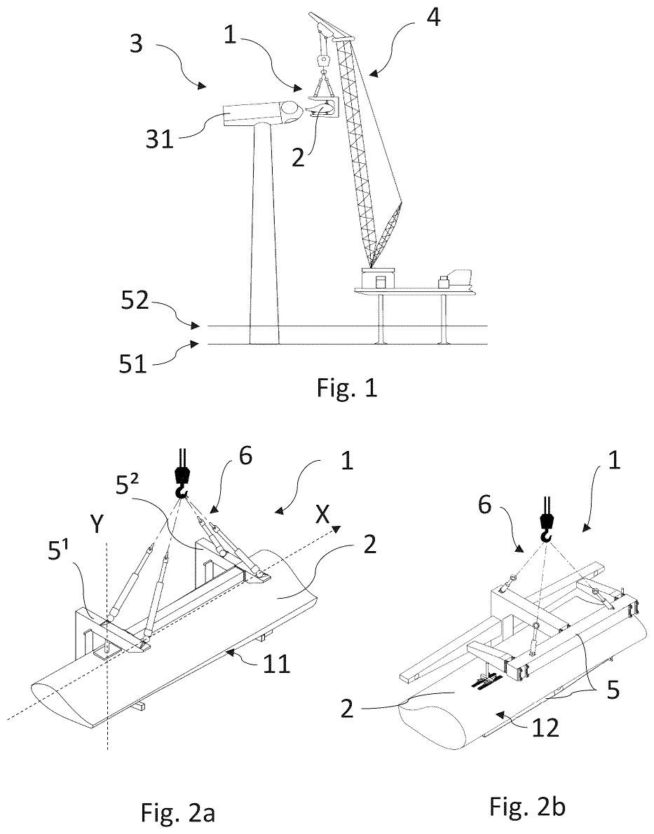

FIG. 1: Illustrating a crane 4 hoisting a blade lifting yoke 1 with a rotor blade. The blade lifting yoke 1 holds a rotor blade 2 while being lifted to the nacelle 31 of a wind turbine 3 by a crane 4, for example an offshore installation. The crane 4 and the wind turbine 3 are both supported on the seabed 51 below sea level 52. Though it is to be understood that the invention is not limited to offshore uses and may be used for any operation involving lifting a rotor blade 2.

FIG. 2a, b: Illustrating two different embodiments of a blade lifting yoke 1 lifting a rotor blade 2. In FIG. 2a, the blade lifting yoke 1 comprises a base section and two holding devices 5¹,5². In this embodiment, the holding devices 5¹,5² are a part of the base section. The blade lifting yoke 1 lifts a rotor blade 2 wherein the rotor blade is in a hoisting position having the trailing edge 11 facing away from the holding devices 5¹,5². The blade lifting yoke 1 comprises a crane attachment section 6 for attachment to a crane 4. The blade lifting yoke 1 has a crane attachment section 6, which is capable of being attached to, for example, a hook. The crane attachment section 6 is also moveably fastened to top of the holding devices 5¹,5², such that the crane is capable of hoisting the blade lifting yoke 1. The rotor plate has a longitudinal axis X along the longitudinal direction of the rotor blade 2. A vertical axis Y is substantially perpendicular to the longitudinal axis X extending from a top part to a bottom part of top of the holding devices 5¹,5².

In FIG. 2b, the blade lifting yoke 1 comprises one holding device 5. In this embodiment, the holding device 5 is a part of a base section. The blade lifting yoke 1 lifts a rotor blade 2, wherein the rotor blade 2 is in a hoisting position having the leading edge 12 facing away from the holding devices 5. The blade lifting yoke 1 comprises a crane attachment section 6 for attachment to a crane 4. The crane attachment section 6 is also moveable fastened to top of the holding device 5, such that the crane is capable of hoisting the blade lifting yoke 1.

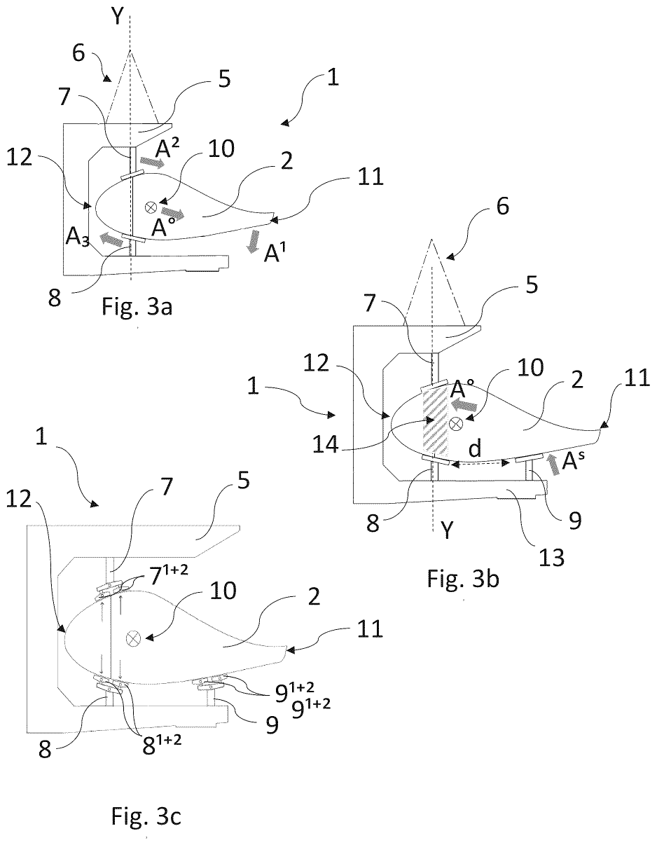

FIG. 3a, b, c: Illustrating a cross sectional embodiment of a blade lifting yoke 1 lifting a rotor blade 2. FIG. 3a illustrates a blade lifting yoke 1 carrying a rotor blade 2 in a hoisting position. The blade lifting yoke 1 has a holding device 5 shaped in a C-shape. The C-shaped has a top part and a bottom part. The holding device 5 is capable of partly surrounding the rotor blade 2. The rotor blade 2 has a first surface facing the upper clamper element 7 and a second surface facing the lower clamping element 8. The rotor blade 2 has a leading edge 12 and a trailing edge 11.

The upper clamping element 7 is adapted to be arranged in contact with the first surface of the rotor blade 2. The lower clamping element 8 is adapted to be arranged in contact with the second surface of rotor blade 2. The rotor blade 2 is arranged in a hoisting position in the blade lifting yoke 1 between an upper clamping element 8 and a lower clamping element 8. The upper clamping element 7 is arranged in a distance substantially perpendicular to the longitudinal direction along the vertical axis Y. The upper clamping element 7 is arranged substantially above the respective lower clamping element 8. The upper clamping element 7 is capable of pressing the rotor blade against the lower clamping element 8 using clamping means. The rotor blade 2 is kept in a substantially fixed position relative to the lifting yoke 1. It is important the clamping pressure is kept as low as possible to avoid any damage to the rotor blade 2 during hoisting operation. The upper clamping element 7 and the lower clamping element 7 is trying to keep the center of gravity 10 of the rotor blade 2 substantially in or near a clamping area. Using only upper clamping element 7 and the lower clamping element 8 to fix the rotor blade 2 is a difficult task.

During a hoisting operation the wing may push the trailing edge 11 downwards, illustrated with the arrow A¹. The upper clamping element 7, which is arranged in a predetermined clamping position relative to the first surface of the rotor blade 2, and the lower clamping element 8, which is arranged in a predetermined clamping position relative to the second surface of the rotor blade 2 are moved away from their respective predetermined clamping positions, illustrated with the arrow A², A³. This causes the center of gravity move outwards and away from a geometric center of the blade lifting yoke 1. The rotor blade 2 will then be in an unsafe and unstable hoisting position.

To be able to hold on to the rotor blade 2, the clamping pressure must be increased. The pressure exposed to the rotor blade 2, may cause damage to the rotor blade 2 eventually.

In FIG. 3b it shows that the C-shaped rotor blade has a top part and a bottom part, wherein the bottom part is an extended bottom part, for example an extended member 13. A support element 9 is attached to the extended member 13. The support element 9 is capable of supporting the lower surface of the rotor blade in a predetermined distance d from the lower clamping element 8. The support element 9 is arranged in a predetermined position between the center of gravity 10 and a trailing edge 11 of the rotor blade 2. The support element 9 is forcing the rotor blade's trailing end upwards, illustrated with the arrow A^{s}. The center of gravity 10 is moved towards the geometric center of the blade lifting yoke 1 as illustrated with the arrow A^{o}, and kept in a stable position substantially in or near a clamping area 14 defined by the upper clamping element 7 and the lower clamping element 8. The rotor blade 2 will then be in a safe and stable hoisting position. The clamping pressure between the upper clamping element and the lower clamping element may be reduced to hold on to the rotor blade 2, because most of the rotor blade's weight is resting on the lower clamping element 8.

Pressure distribution to an area may be reduced by enlarging the surface of the clamping position area, wherein the upper clamping element and the lower clamping element attack the rotor blade 2. This provides a firm clamping with reduced pressure to surface of the clamping area in each of the clamping positions.

The rotor blade is arranged in a resting position on the lower clamping elements 8. The support element 9 may be arranged in the predetermined support position relative to the rotor blade 2 and the lower clamping elements 8. The rotor blade 2 may be arranged in the resting position, wherein more than 50% of the weight of the rotor blade 2 is resting on the lower clamping element 8. Preferably, more than 60%, and most preferably, more than at least 70% of the weight of the rotor blade 2 is resting on the lower clamping element 8. The rotor blade is arranged in the resting position in the blade lifting yoke 1, wherein the blade lifting yoke 1 is arranged in a closed position. The blade lifting yoke 1 may be arranged in a releasable locked position, such that the blade lifting yoke 1 does not unintentionally open during hoisting operation.

In FIG. 3c it shows that the C-shaped rotor blade has a top part and a bottom part, wherein the bottom part is an extended bottom part 13. Rotor blade 2 comprises different shapes and lengths depending on the specific type of rotor blade 2. The upper clamping element 7 and the second lower clamping element 8 may be pivotally attached to the holding device 5, such that it is easy for each of the clamping elements to follow the surface of the rotor blade 2. The upper clamping element 7 may be arranged in a pivot position relative to the first surface, such that the upper clamping element 7 clamping surface is in contact with the first surface of the rotor blade 2. The lower clamping element 8 may be arranged in a pivot position relative to the second surface, such that the lower clamping element clamping surface is in contact with the second surface of the rotor blade 2. The support element 9 may be arranged in a pivot position relative to the second surface, such that the support element 9 support surface is in contact with the second surface of the rotor blade 2.

The upper clamping element 7 may comprise a first and a second upper clamping member 7¹⁺² pivotally attached to the upper clamping element 7. The lower clamping element 8 comprise a first and a second lower clamping member 8¹⁺² pivotally attached to the lower clamping element 8. The support element 9 comprise a first and a second support member 9¹⁺² pivotally attached to said support element. The area which is exposed of pressure may be increased using a higher number of members connected to the elements, such that the three-point principle can still ensure static stability of the wind turbine rotor blade relative to the blade lifting yoke.

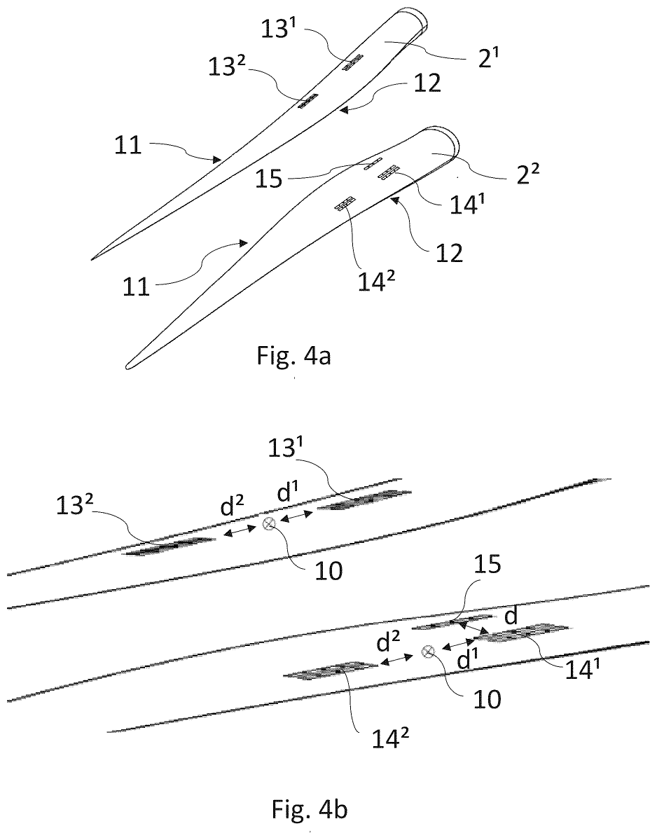

FIG. 4a, b illustrating the predetermined support and clamping positions 13¹,13², 14¹,14², 15 on a rotor blade's 2 surface. The support element's support position 15 may have a support distance which extend from the center of gravity 10 to the trailing edge 11 of the rotor blade 2. The support elements affect the position of the center of gravity 10 when the rotor blade 2 is arranged in the blade lifting yoke 1, for example during hoisting operation. The predetermined support position 15 related to the second surface may be located a predetermined support distance from the trailing edge 11. The distances between the first or second lower clamping elements clamping position 14¹,14² and the support elements support position 15 ensures the static stability of the rotor blade 2, when the rotor blade 2 is arranged in the blade lifting yoke 1 with the use of to the three-point principle. The three forces provided to the first and second lower clamping elements predefined clamping position 14¹,14² and the support element support position 15 are calculated, such that a single primary force is applied between two additional counterforces. The sum of all three forces substantially equal zero. The support distance is determined for each type of rotor blade 2 selected.

FIG. 4b shows a first clamping distance d¹ between the rotor blade's center of gravity and the first upper and lower clamping elements at the first upper and lower clamping position 13¹,14¹ which may be different from a second clamping distance d² between the rotor blade's center of gravity and the second upper and lower clamping elements at the second upper and lower clamping position 13²,14². The first clamping pressure provided between the first upper and lower clamping element at the first upper and lower clamping position 13¹,14¹ may be equal to or different than the second clamping pressure provided between the second upper and lower clamping element at the second upper and lower clamping position 13²,14².

The support element may be in contact with the second surface. The support element may be located a support distance from the trailing edge. The distance between the first or second lower clamping element ensures the static stability of the wind turbine rotor blade when arranged in the blade lifting yoke according to the three-point principle. The three forces provided to the first and second lower clamping elements and the support element positions are calculated in such that a single primary force is applied between two additional counterforces. The sum of all three forces substantially equal zero. The support distance is determined for each type of rotor blade selected to be hoisted.

The support element may be arranged in a support distance may be defined when calculating a support distance. The support distance may extend from the center of gravity to the trailing edge of the rotor blade. The support elements affect the position of center of gravity when the rotor blade is arranged in the blade lifting yoke, for example during hoisting operation.

1. A method for lifting a wind turbine rotor blade, comprising:
using a blade lifting yoke, the blade lifting yoke comprising:
at least one crane attachment section for attachment to a crane;
a base section;
at least one holding device;
a first upper and lower clamping element;
a second upper and lower clamping element; and
a support element attached to the at least one holding device comprising an extended member, wherein the extended member extends away from the nearest lower clamping element such that the support element is capable of supporting a lower surface of the wind turbine rotor blade in a predetermined distance from the first or second lower clamping elements;
wherein each of the first and second upper clamping elements are arranged above the respective first and second lower clamping elements, which are arranged in each respective first and second distances substantially perpendicular to a longitudinal direction of the rotor blade above the respective first and second lower clamping elements; and
wherein the first and second upper clamping elements configured for pressing the rotor blade against the respective first and second lower clamping elements;
determining:
a first and a second clamping position for the first upper and lower clamping elements and the second upper and lower clamping elements;
a support position of the support element relative to a selected rotor blade when arranged in the blade lifting yoke; and
a clamping pressure between the first and second upper clamping elements and the respective first and second lower clamping elements;
arranging the selected rotor blade relative to the at least one holding device, such that said first and second upper clamping elements are arranged adjacent to a first surface of said selected rotor blade at the predetermined clamping positions of the respective first and second upper clamping elements, and said first and second lower clamping elements are arranged adjacent to a second surface of said selected rotor blade relative to the predetermined clamping position of the first and second lower clamping elements;
arranging said support element adjacent to the second surface in a predetermined distance from the first and/or second lower clamping element, wherein the support element is arranged in a predetermined support position between a center of gravity and a trailing edge of the wind turbine rotor blade;
adjusting said clamping pressure between said first and second upper clamping elements and said respective first and second lower clamping elements using a clamping mechanism, keeping the center of gravity of a wind turbine rotor blade substantially in or near of a rotor blade's clamping area, wherein the clamping area is defined by the first and a second clamping positions of the first and second upper clamping elements and the first and second lower clamping elements;
wherein during a hoisting operation, the first and second upper clamping elements, the first and second lower clamping elements and the support element provide static stability of the wind turbine rotor blade relative to the blade lifting yoke.

2. The method according to claim 1, wherein the support element is located adjacent to the second surface in a predetermined support position in a support distance from the trailing edge, such that more than 70% of a rotor blade's weight is resting on the first and the second lower clamping elements.

3. The method according to claim 1, wherein a first clamping pressure provided between the first upper and lower clamping elements is different than a second clamping pressure provided between the second upper and lower clamping elements.

4. The method according to claim 1, wherein a first clamping distance between a wind turbine rotor blade's center of gravity and the first upper and lower clamping element is different than a second clamping distance between a wind turbine rotor blade's center of gravity and the second upper and lower clamping element.

5. The method according to claim 1, wherein the clamping pressure is determined based on at least one information related to weather conditions.

6. A blade lifting yoke for lifting a wind turbine rotor blade, comprising:
at least one crane attachment section for attachment to a crane;
a base section;
at least one holding device;
a first upper and lower clamping elements;
a second upper and lower clamping elements; and
a support element attached to the at least one holding device;
wherein:
the first and second upper clamping elements are arranged in a distance to each other above the respective first and second lower clamping elements;
the first and second upper clamping elements are configured for pressing the rotor blade against the respective first and second lower clamping elements;
one of the at least one holding devices comprises a support element adapted to be arranged in contact with a second surface of the wind turbine rotor blade in a predetermined distance from one of the first and/or second lower clamping element;
the at least one holding device comprises an extended member, wherein the support element is attached to the extended member, wherein the extended member extends away from the nearest lower clamping element, such that the support element is capable of supporting the lower surface of said rotor blade in a predetermined distance from the first or second lower clamping elements;
a clamping mechanism is configured to be in contact with the said first and second upper clamping members and said first and second lower clamping elements, wherein the clamping mechanism is configured to clamp the wind turbine rotor blade with at least one clamping pressure between the first and second upper clamping element and the respective first and second lower clamping elements, such that during hoisting operations, the first and second upper clamping elements, the first and second lower clamping elements, and the support element provide static stability of the wind turbine rotor blade relative to the said blade lifting yoke.

7. The blade lifting yoke according to claim 6, wherein the first and/or second upper clamping element and/or the first and/or second lower clamping element are pivotally attached to the at least one holding device.

8. The blade lifting yoke according to claim 6, wherein the first or second upper clamping elements comprise a first and a second upper clamping member pivotally attached to said first or second upper clamping element, and/or said first or second lower clamping elements comprise a first and a second lower clamping member pivotally attached to said first or second lower clamping element.

9. The blade lifting yoke according to claim 6, wherein said first and second upper clamping elements comprise a first and a second upper clamping member pivotally attached to said first and second upper clamping element, and/or said first and second lower clamping elements comprise a first and a second lower clamping member pivotally attached to said first and second lower clamping element.

10. The blade lifting yoke according to claim 8, wherein a first and a second clamping sub-members are pivotally attached to each of said clamping member.

11. The method according to claim 2, wherein a first clamping pressure provided between the first upper and lower clamping elements is different than a second clamping pressure provided between the second upper and lower clamping elements.

12. The method according to claim 2, wherein a first clamping distance between a wind turbine rotor blade's center of gravity and the first upper and lower clamping element is different than a second clamping distance between a wind turbine rotor blade's center of gravity and the second upper and lower clamping element.

13. The method according to claim 3, wherein a first clamping distance between a wind turbine rotor blade's center of gravity and the first upper and lower clamping element is different than a second clamping distance between a wind turbine rotor blade's center of gravity and the second upper and lower clamping element.

14. The method according to claim 11, wherein a first clamping distance between a wind turbine rotor blade's center of gravity and the first upper and lower clamping element is different than a second clamping distance between a wind turbine rotor blade's center of gravity and the second upper and lower clamping element.

15. The blade lifting yoke according to claim 6, wherein said support element comprises a first and a second support member pivotally attached to said support element.

16. The blade lifting yoke according to claim 7, wherein the first or second upper clamping elements comprise a first and a second upper clamping member pivotally attached to said first or second upper clamping element, and/or said first or second lower clamping elements comprise a first and a second lower clamping member pivotally attached to said first or second lower clamping element.

17. The blade lifting yoke according to claim 7, wherein said first and second upper clamping elements comprise a first and a second upper clamping member pivotally attached to said first and second upper clamping element, and/or said first and second lower clamping elements comprise a first and a second lower clamping member pivotally attached to said first and second lower clamping element.

18. The blade lifting yoke according to claim 7, wherein said support element comprises a first and a second support member pivotally attached to said support element.

19. The blade lifting yoke according to claim 16, wherein said support element comprises a first and a second support member pivotally attached to said support element.

20. The blade lifting yoke according to claim 17, wherein said support element comprises a first and a second support member pivotally attached to said support element.
